(19) United States
(12) Patent Application Publication
(10) Pub. No.: US 2022/0199986 A1
(43) Pub. Date: Jun. 23, 2022

(54) NEGATIVE ELECTRODE MATERIAL, ELECTROCHEMICAL DEVICE CONTAINING SAME, AND ELECTRONIC DEVICE

(71) Applicant: Ningde Amperex Technology Limited, Ningde (CN)

(72) Inventors: Ting ZHANG, Ningde (CN); Daoyi JIANG, Ningde (CN); Zhihuan CHEN, Ningde (CN); Hang CUI, Ningde (CN)

(73) Assignee: Ningde Amperex Technology Limited, Ningde (CN)

(21) Appl. No.: 17/690,159

(22) Filed: Mar. 9, 2022

Related U.S. Application Data
(63) Continuation of application No. PCT/CN2019/128832, filed on Dec. 26, 2019.

(51) Int. Cl. H01M 4/36; H01M 4/62; H01M 4/48; H01M 10/0525

(52) U.S. Cl. CPC H01M 4/366; H01M 4/622; H01M 2004/027; H01M 4/483; H01M 10/0525; H01M 4/625

(57) ABSTRACT

A negative electrode material includes silicon-based particles. The silicon-based particles include a silicon-containing substrate and a polymer layer. The polymer layer exists on at least a part of a surface of the silicon-containing substrate. The polymer layer includes carbon nanotubes and alkali metal ions. The alkali metal ions include Li+, Na+, K+, or any combination thereof. Based on a total weight of the silicon-based particles, a content of the alkali metal ions is approximately 50˜5,000 ppm. A lithium-ion battery prepared by using the negative active material achieves a lower resistance, higher first-time efficiency, higher cycle performance, and higher rate performance.

### CROSS-REFERENCE TO RELATED APPLICATIONS

This application is a national phase application of PCT application PCT/CN2019/128832, filed on Dec. 26, 2019, the disclosure of which is hereby incorporated by reference in its entirety.

### TECHNICAL FIELD

This application relates to the field of energy storage, and in particular, to a negative electrode material, an electrochemical device containing same, and an electronic device, especially a lithium-ion battery.

### BACKGROUND

With popularization of consumer electronics products such as a notebook computer, a mobile phone, a tablet computer, a mobile power supply, and an unmanned aerial vehicle, requirements on an electrochemical device contained in such products are increasingly higher. For example, a battery not only needs to be light, but also needs to have a high capacity and a long service life. Lithium-ion batteries have occupied the mainstream position in the market by virtue of their superior advantages such as a high energy density, high safety, no memory effect, and a long service life.

### SUMMARY

Embodiments of this application provide a negative electrode material in an attempt to solve at least one problem in the related art to at least some extent. The embodiments of this application further provide a negative electrode that uses the negative electrode material, an electrochemical device, and an electronic device.

In an embodiment, this application provides a negative electrode material. The negative electrode material includes silicon-based particles. The silicon-based particles include a silicon-containing substrate and a polymer layer. The polymer layer exists on at least a part of a surface of the silicon-containing substrate. The polymer layer includes carbon nanotubes and alkali metal ions. The alkali metal ions include Li+, Na+, K+, or any combination thereof. Based on a total weight of the silicon-based particles, a content of the alkali metal ions is approximately 50˜5,000 ppm.

In another embodiment, this application provides a negative electrode, including the negative electrode material according to the embodiment of this application.

In another embodiment, this application provides an electrochemical device, including the negative electrode according to the embodiment of this application.

In another embodiment, this application provides an electronic device, including the electrochemical device according to the embodiment of this application.

A lithium-ion battery prepared by using a negative active material according to this application achieves a lower resistance, higher first-time efficiency, higher cycle performance, and higher rate performance.

Additional aspects and advantages of the embodiments of this application will be described and illustrated in part later herein or expounded through implementation of the embodiments of this application.

### BRIEF DESCRIPTION OF DRAWINGS

For ease of describing the embodiments of this application, the following outlines the drawings necessary for describing the embodiments of this application or the prior art. Apparently, the drawings outlined below are merely a part of embodiments in this application. Without making any creative efforts, a person skilled in the art can still obtain the drawings of other embodiments according to the structures illustrated in these drawings.

FIG. 1 is a schematic structural diagram of a silicon-based negative active material according to an embodiment of this application;

FIG. 2 shows a scanning electron microscope (SEM) image of a surface of a silicon-based negative active material according to Comparative Embodiment 5 of this application;

FIG. 3 shows an SEM image of a surface of a silicon-based negative active material according to Embodiment 1 of this application;

FIG. 4 shows an SEM image of a surface of a silicon-based negative active material according to Embodiment 3 of this application; and

FIG. 5 shows an SEM image of a surface of a silicon-based negative active material according to Embodiment 6 of this application.

### DETAILED DESCRIPTION

Embodiments of this application will be described in detail below. The embodiments of this application are not to be construed as a limitation on this application.

The term “approximately” used this application is intended to describe and represent small variations. When used with reference to an event or situation, the terms may denote an example in which the event or situation occurs exactly and an example in which the event or situation occurs very approximately. For example, when used together with a numerical value, the term may represent a variation range falling within ±10% of the numerical value, such as ±5%, ±4%, ±3%, ±2%, ±1%, ±0.5%, ±0.1%, or ±0.05% of the numerical value.

In addition, a quantity, a ratio, or another numerical value is sometimes expressed in a range format herein. Understandably, such a range format is for convenience and brevity, and shall be flexibly understood to include not only the numerical values explicitly specified and defined in the range, but also all individual numerical values or sub-ranges covered in the range as if each individual numerical value and each sub-range were explicitly specified.

In the description of specific embodiments and claims, a list of items referred to by using the terms such as “one of”, “one thereof”, “one type of” or other similar terms may mean any one of the listed items. For example, if items A and B are listed, the phrase “one of A and B” means A alone, or B alone. In another example, if items A, B, and C are listed, then the phrases “one of A, B, and C” and “one of A, B, or C” mean: A alone; B alone; or C alone. The item A may include a single element or a plurality of elements. The item B may include a single element or a plurality of elements. The item C may include a single element or a plurality of elements.

In the description of embodiments and claims, a list of items referred to by using the terms such as “at least one of”, “at least one thereof”, “at least one type of” or other similar terms may mean any combination of the listed items. For example, if items A and B are listed, the phrases “at least one of A and B” and “at least one of A or B” mean: A alone; B alone; or both A and B. In another example, if items A, B, and C are listed, the phrases “at least one of A, B, and C” and “at least one of A, B, or C” mean: A alone; B alone; C alone; A and B (excluding C); A and C (excluding B); B and C (excluding A); or all of A, B, and C. The item A may include a single element or a plurality of elements. The item B may include a single element or a plurality of elements. The item C may include a single element or a plurality of elements.

I. Negative Electrode Material

In some embodiments, this application provides a negative electrode material. The negative electrode material includes silicon-based particles. The silicon-based particles include a silicon-containing substrate and a polymer layer. The polymer layer exists on at least a part of a surface of the silicon-containing substrate. The polymer layer includes carbon nanotubes and alkali metal ions. The alkali metal ions include Li+, Na+, K+, or any combination thereof. Based on a total weight of the silicon-based particles, a content of the alkali metal ions is approximately 50˜5,000 ppm. In other embodiments, the polymer layer coats an entire surface of the silicon-containing substrate.

In some embodiments, based on the total weight of the silicon-based particles, a content of the alkali metal ions is approximately 70˜5,000 ppm. In some embodiments, based on the total weight of the silicon-based particles, the content of the alkali metal ions is approximately 10˜05,000 ppm. In some embodiments, based on the total weight of the silicon-based particles, the content of the alkali metal ions is approximately 500 ppm, approximately 1,000 ppm, approximately 1,500 ppm, approximately 2,000 ppm, approximately 2,500 ppm, approximately 3,000 ppm, approximately 3,500 ppm, approximately 4,000 ppm, approximately 4,500 ppm, or a range formed by any two of such values.

In some embodiments, the polymer layer includes lithium carboxymethyl cellulose (CMC-Li), sodium carboxymethyl cellulose (CMC-Na), potassium carboxymethyl cellulose (CMC-K), lithium polyacrylic acid (PAA-Li), sodium polyacrylic acid (PAA-Na), potassium polyacrylic acid (PAA-K), lithium alginate (ALG-Li), sodium alginate (ALG-Na), potassium alginate (ALG-K), or any combination thereof.

In some embodiments, an average particle size of the silicon-based particles is approximately 500 nm˜30 μm. In some embodiments, the average particle size of the silicon-based particles is approximately 1 μm˜25 μm. In some embodiments, the average particle size of the silicon-based particles is approximately 5 μm, approximately 10 μm, approximately 15 μm, approximately 20 μm, or a range formed by any two of such values.

In some embodiments, the silicon-containing substrate includes SiOₓ, where 0.6≤x≤1.5.

In some embodiments, the silicon-containing substrate includes Si, SiO, SiO₂, SiC, or any combination thereof.

In some embodiments, the particle size of Si is less than approximately 100 nm. In some embodiments, the particle size of Si is less than approximately 50 nm. In some embodiments, the particle size of Si is less than approximately 20 nm. In some embodiments, the particle size of Si is less than approximately 5 nm. In some embodiments, the particle size of Si is less than approximately 2 nm. In some embodiments, the particle size of Si is less than approximately 0.5 nm. In some embodiments, the particle size of Si is approximately 10 nm, approximately 20 nm, approximately 30 nm, approximately 40 nm, approximately 50 nm, approximately 60 nm, approximately 70 nm, approximately 80 nm, approximately 90 nm, or a range formed by any two of such values.

In some embodiments, based on the total weight of the silicon-based particles, the content of the polymer layer is approximately 0.05˜15 wt %. In some embodiments, based on the total weight of the silicon-based particles, the content of the polymer layer is approximately 1˜10 wt %. In some embodiments, based on the total weight of the silicon-based particles, the content of the polymer layer is approximately 2 wt %, approximately 3 wt %, approximately 4 wt %, approximately 5 wt %, approximately 6 wt %, approximately 7 wt %, approximately 8 wt %, approximately 9 wt %, approximately 10 wt %, approximately 11 wt %, approximately 12 wt %, approximately 13 wt %, approximately 14 wt %, or a range formed by any two of such values.

In some embodiments, a thickness of the polymer layer is approximately 5 nm˜200 nm. In some embodiments, the thickness of the polymer layer is approximately 10 nm˜150 nm. In some embodiments, the thickness of the polymer layer is approximately 50 nm˜100 nm. In some embodiments, the thickness of the polymer layer is approximately 10 nm, approximately 20 nm, approximately 30 nm, approximately 40 nm, approximately 50 nm, approximately 60 nm, approximately 70 nm, approximately 80 nm, approximately 90 nm, approximately 100 nm, approximately 110 nm, approximately 120 nm, Approximately 130 nm, approximately 140 nm, approximately 150 nm, approximately 160 nm, approximately 170 nm, approximately 180 nm, approximately 190 nm, approximately 200 nm, or a range formed by any two of such values.

In some embodiments, the carbon nanotubes include a single-walled carbon nanotube, a multi-walled carbon nanotube, or a combination thereof.

In some embodiments, a diameter of the carbon nanotubes is approximately 1˜30 nm. In some embodiments, the diameter of the carbon nanotubes is approximately 5˜20 nm. In some embodiments, the diameter of the carbon nanotubes is approximately 10 nm, approximately 15 nm, approximately 20 nm, approximately 25 nm, approximately 30 nm, or a range formed by any two of such values.

In some embodiments, a length-to-diameter ratio of the carbon nanotubes is approximately 50˜30,000. In some embodiments, the length-to-diameter ratio of the carbon nanotubes is approximately 100˜20,000. In some embodiments, the length-to-diameter ratio of the carbon nanotubes is approximately 500, approximately 2,000, approximately 5,000, approximately 10,000, approximately 15,000, approximately 2,000, approximately 25,000, approximately 30,000, or a range formed by any two of such values.

In some embodiments, based on the total weight of the silicon-based particles, a content of the carbon nanotubes is approximately 0.01˜10 wt %. In some embodiments, based on the total weight of the silicon-based particles, the content of the carbon nanotubes is approximately 1˜8 wt %. In some embodiments, based on the total weight of the silicon-based particles, the content of the carbon nanotubes is approximately 0.02 wt %, approximately 0.05 wt %, approximately 0.1 wt %, approximately 0.5 wt %, approximately 1 wt %, approximately 1.5 wt %, approximately 2.5 wt %, approximately 2 wt %, approximately 3 wt %, approximately 4 wt %, approximately 5 wt %, approximately 6 wt %, approximately 7 wt %, approximately 8 wt %, approximately 9 wt %, approximately 10 wt %, or a range formed by any two of such values.

In some embodiments, a weight ratio of a polymer to the carbon nanotubes in the polymer layer is approximately 1:10˜10:1. In some embodiments, the weight ratio of the polymer to the carbon nanotubes in the polymer layer is approximately 1:8, approximately 1:5, approximately 1:3, approximately 1:1, approximately 3:1, approximately 5:1, approximately 7:1, approximately 10:1, or a range formed by any two of such values.

In some embodiments, a specific surface area of the silicon-based particles is approximately 2.5˜15 m²/g. In some embodiments, the specific surface area of the silicon-based particles is approximately 5˜10 m²/g. In some embodiments, the specific surface area of the silicon-based particles is approximately 3 m²/g, approximately 4 m²/g, approximately 6 m²/g, approximately 8 m²/g, approximately 10 m²/g, approximately 12 m²/g, approximately 14 m²/g, or a range formed by any two of such values.

In some embodiments, any one of the foregoing negative electrode materials further includes graphite particles. In some embodiments, a weight ratio of the graphite particles to the silicon-based particles is approximately 3:1˜20:1. In some embodiments, the weight ratio of the graphite particles to the silicon-based particles is approximately 3:1, approximately 5:1, approximately 6:1, approximately 7:1, approximately 10:1, approximately 12:1, approximately 15:1, approximately 18:1, approximately 20:1, or a range formed by any two of such values.

II. Method for Preparing a Negative Electrode Material

An embodiment of this application provides a method for preparing any one of the foregoing negative electrode materials. The method includes:

(1) adding carbon nanotube powder into a polymer-containing solution, and dispersing the powder for approximately 1˜24 hours to obtain a slurry;

(2) adding a silicon-containing substrate into the slurry, and dispersing the substrate for approximately 2˜4 hours to obtain a mixed slurry; and

(3) removing a solvent in the mixed slurry to obtain silicon-based particles.

In some embodiments, the method further includes a step of mixing the silicon-based particles with graphite particles. In some embodiments, the weight ratio of the graphite particles to the silicon-based particles is approximately 3:1, approximately 5:1, approximately 6:1, approximately 7:1, approximately 10:1, approximately 12:1, approximately 15:1, approximately 18:1, approximately 20:1, or a range formed by any two of such values.

In some embodiments, definitions of the silicon-containing substrate, carbon nanotubes, and a polymer are as described above, respectively.

In some embodiments, a weight ratio of the polymer to the carbon nanotube powder is approximately 1:10˜10:1. In some embodiments, the weight ratio of the polymer to the carbon nanotube powder is approximately 1:8, approximately 1:5, approximately 1:3, approximately 1:1, approximately 3:1, approximately 5:1, approximately 7:1, approximately 10:1, or a range formed by any two of such values.

In some embodiments, a weight ratio of the silicon-containing substrate to the polymer is approximately 200:1˜5:1. In some embodiments, the weight ratio of the silicon-containing substrate to the polymer is approximately 150:1˜5:1. In some embodiments, the weight ratio of the silicon-containing substrate to the polymer is approximately 200:1, approximately 150:1, approximately 100:1, approximately 50:1, approximately 10:1, approximately 1:1, approximately 5:1, or a range formed by any two of such values.

In some embodiments, the solvent includes water, ethanol, methanol, n-hexane, N,N-dimethylformamide, pyrrolidone, acetone, toluene, isopropanol, or any combination thereof.

In some embodiments, a dispersion time in step (1) is approximately 1 h, approximately 5 h, approximately 10 h, approximately 15 h, approximately 20 h, approximately 24 h, or a range formed by any two of such values.

In some embodiments, the dispersion time in step (2) is approximately 2 h, approximately 2.5 h, approximately 3 h, approximately 3.5 h, approximately 4 h, or a range formed by any two of such values.

In some embodiments, the method for removing the solvent in step (3) includes rotary evaporation, spray drying, filtering, freeze-drying, or any combination thereof.

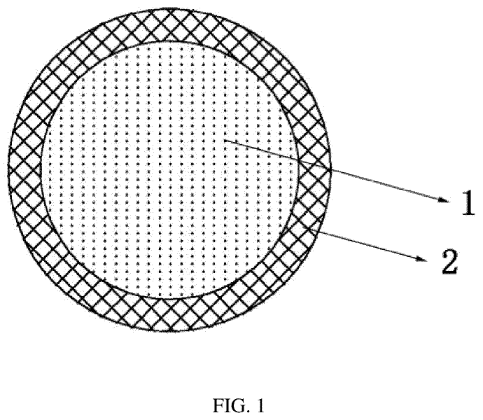

FIG. 1 is a schematic structural diagram of a silicon-based negative active material according to an embodiment of this application. In the structure, an inner layer 1 is a silicon-containing substrate, and an outer layer 2 is a polymer layer including carbon nanotubes. The polymer layer including carbon nanotubes (CNT) coats a surface of the silicon-containing substrate. The CNT may be bound onto the surface of the silicon-based negative active material by using the polymer, thereby helping to improve interface stability of the CNT on the surface of the negative active material and enhance cycle performance.

The silicon-based negative electrode material has a gram capacity of 1,500˜4,200 mAh/g, and is considered to be the most promising next-generation negative electrode material of lithium-ion batteries. However, low conductivity of silicon, an approximately 300% volume expansion rate of the silicon-based negative electrode material in a charge and discharge process, and an unstable solid electrolyte interphase membrane (SEI) of the material hinder further application of the silicon-based negative electrode material to some extent. Currently, the main methods for improving the cycle stability and the rate performance of the silicon-based material are as follows: designing a porous silicon-based material, reducing a size of a silicon-oxygen material, and using an oxide coating, a polymer coating, a carbon material coating, and the like. Compared with a bulk material, a porous silicon-based material designed and a smaller size of the silicon-oxygen material can improve the rate performance to some extent. However, with ongoing cycles, occurrence of side reactions, and uncontrollable growth of an SEI film, the cycle stability of the material is further limited. The oxide coating and the polymer coating can avoid contact between an electrolytic solution and an electrode material. However, due to poor conductivity of the coating, the coating increases an electrochemical resistance. In addition, the coating is prone to be damaged in a process of lithium deintercalation, thereby reducing the cycle life. Among such coatings, the carbon material coating can provide excellent conductivity, and is main technology applied currently. However, during processing of an electrode plate of a battery, a carbon-coated silicon-based material is likely to be decarburized due to repeated shearing forces, thereby affecting a Coulombic efficiency. On the other hand, due to expansion, contraction, and ruptures of silicon during repeated cycles, a carbon layer is also likely to flake from the substrate. With the formation of the SEI and wrapping of by-products, the electrochemical resistance and polarization increase, thereby affecting the cycle life.

In view of this, avoiding direct contact between the electrolytic solution and the silicon-based material while improving conductivity and enhancing a bonding force and stability of the coating are rather significant to suppression of volume expansion of the silicon-based material and further improvement of the cycle life and enhancement of the stability of the cycle structure.

To solve the foregoing problems, this application firstly prepares silicon-based particles that include a polymer layer, and the polymer layer exists on at least a part of the surface of the silicon-containing substrate. The polymer layer includes carbon nanotubes (CNT). Existence of the CNT improves conductivity of the negative active material. In addition, the polymer layer including the carbon nanotubes serves as an outer surface of the silicon-based negative active material, and can bind the CNT onto the surface of the negative active material by using the polymer, thereby helping to improve interface stability of the CNT on the surface of the negative active material, suppress the volume expansion of the silicon-based material, and enhance the cycle stability of the material.

When the polymer layer is introduced to the surface of the silicon-containing substrate, an alkali metal-containing polymer such as sodium carboxymethyl cellulose is commonly used. The inventor of this application unexpectedly finds that if the content of alkali metal is too high, the polymer itself is likely to form a self connection of a carboxyl-containing polymer. In this way, the resistance of the silicon material is too high after the polymer layer is formed on the surface, thereby greatly reducing the cycle stability and the rate performance of the silicon material. Therefore, when the alkali metal-containing polymer layer is introduced on the surface of the silicon-containing substrate, the amount of introduced alkali metal needs to be controlled, so as to improve the interface stability on the surface of the material and enhance the cycle stability and the rate performance.

The inventor of this application finds that when the content of alkali metal ions introduced by the polymer into the silicon-based negative active material falls in the range of approximately 50˜5,000 ppm, the lithium-ion battery prepared by using the silicon-based negative active material achieves a lower resistance, higher first-time efficiency, higher cycle performance, and higher rate performance.

III. Negative Electrode

An embodiment of this application provides a negative electrode. The negative electrode includes a current collector and a negative active material layer disposed on the current collector. The negative active material layer includes the negative electrode material according to the embodiment of this application.

In some embodiments, the negative active material layer includes a binder. In some embodiments, the binder includes, but is not limited to: polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly (1,1-difluoroethylene), polyethylene, polypropylene, styrene-butadiene rubber, acrylic styrene-butadiene rubber, epoxy resin, or nylon.

In some embodiments, the negative active material layer includes a conductive material. In some embodiments, the conductive material includes, but is not limited to: natural graphite, artificial graphite, carbon black, acetylene black, Ketjen black, carbon fiber, metal powder, metal fiber, copper, nickel, aluminum, silver, or a polyphenylene derivative.

In some embodiments, the current collector includes, but is not limited to: a copper foil, a nickel foil, a stainless steel foil, a titanium foil, foamed nickel, foamed copper, or a polymer substrate coated with a conductive metal.

In some embodiments, the negative electrode may be obtained according to the following method: mixing an active material, a conductive material, and a binder in a solvent to prepare an active material composite, and coating the active material composite onto the current collector.

In some embodiments, the solvent may include, but is not limited to: deionized water, and N-methyl-pyrrolidone.

IV. Positive Electrode

The material, composition, and manufacturing method of the positive electrode that are applicable to the embodiments of this application include any technology disclosed in the prior art. In some embodiments, the positive electrode is the positive electrode specified in the US patent application U.S. Pat. No. 9,812,739B, which is incorporated herein by reference in its entirety.

In some embodiments, the positive electrode includes a current collector and a positive active material layer disposed on the current collector.

In some embodiments, the positive active material includes, but is not limited to, lithium cobalt oxide (LiCoO₂), a lithium nickel-cobalt-manganese (NCM) ternary material, lithium ferrous phosphate (LiFePO₄), or lithium manganese oxide (LiMn₂O₄).

In some embodiments, the positive active material layer further includes a binder, and optionally includes a conductive material. The binder improves bonding between particles of the positive-electrode active material and bonding between the positive-electrode active material and a current collector.

In some embodiments, the binder includes, but is not limited to: polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly (1,1-difluoroethylene), polyethylene, polypropylene, styrene-butadiene rubber, acrylic styrene-butadiene rubber, epoxy resin, or nylon.

In some embodiments, the conductive material includes, but is not limited to, a carbon-based material, a metal-based material, a conductive polymer, and a mixture thereof. In some embodiments, the carbon-based material is selected from natural graphite, artificial graphite, carbon black, acetylene black, Ketjen black, carbon fiber, or any combination thereof. In some embodiments, the metal-based material is selected from metal powder, metal fiber, copper, nickel, aluminum, or silver. In some embodiments, the conductive polymer is a polyphenylene derivative.

In some embodiments, the current collector may include, but is not limited to aluminum.

The positive electrode may be prepared according to a preparation method known in the art. For example, the positive electrode may be obtained according to the following method: mixing an active material, a conductive material, and a binder in a solvent to prepare an active material composite, and coating the active material composite onto the current collector. In some embodiments, the solvent may include, but is not limited to N-methyl-pyrrolidone.

V. Electrolytic Solution

The electrolytic solution applicable to the embodiments of this application may be an electrolytic solution known in the prior art.

In some embodiments, the electrolytic solution includes an organic solvent, a lithium salt, and an additive. The organic solvent of the electrolytic solution according to this application may be any organic solvent known in the prior art that can be used as a solvent of the electrolytic solution. An electrolyte used in the electrolytic solution according to this application is not limited, and may be any electrolyte known in the prior art. The additive of the electrolytic solution according to this application may be any additive known in the prior art that can be used as an additive of the electrolytic solution.

In some embodiments, the organic solvent includes, but is not limited to: ethylene carbonate (EC), propylene carbonate (PC), diethyl carbonate (DEC), ethyl methyl carbonate (EMC), dimethyl carbonate (DMC), propylene carbonate, or ethyl propionate.

In some embodiments, the lithium salt includes at least one of an organic lithium salt or an inorganic lithium salt.

In some embodiments, the lithium salt includes, but is not limited to: lithium hexafluorophosphate (LiPF₆), lithium tetrafluoroborate (LiBF₄), lithium difluorophosphate (LiPO₂F₂), lithium bistrifluoromethanesulfonimide LiN (CF₃SO₂)₂ (LiTFSI), lithium bis(fluorosulfonyl)imide Li(N(SO₂F)₂) (LiFSI), lithium bis(oxalate) borate LiB(C₂O₄)₂ (LiBOB), or lithium difluoro(oxalate)borate LiBF₂(C₂O₄) (LiDFOB).

In some embodiments, a concentration of the lithium salt in the electrolytic solution is approximately 0.5˜3 mol/L, approximately 0.5˜2 mol/L, or approximately 0.8˜1.5 mol/L.

VI. Separator

In some embodiments, a separator is disposed between the positive electrode and the negative electrode to prevent short circuit. The material and the shape of the separator applicable to the embodiments of this application are not particularly limited, and may be based on any technology disclosed in the prior art. In some embodiments, the separator includes a polymer or an inorganic compound or the like formed from a material that is stable to the electrolytic solution according to this application.

For example, the separator may include a substrate layer and a surface treatment layer. The substrate layer is a non-woven fabric, film or composite film, which, in each case, have a porous structure. The material of the substrate layer is selected from at least one of polyethylene, polypropylene, polyethylene terephthalate, and polyimide. Specifically, the material of the substrate layer may be a polypropylene porous film, a polyethylene porous film, a polypropylene non-woven fabric, a polyethylene non-woven fabric, or a polypropylene-polyethylene-polypropylene porous composite film.

A surface treatment layer is disposed on at least one surface of the substrate layer. The surface treatment layer may be a polymer layer or an inorganic compound layer, or a layer formed by mixing a polymer and an inorganic compound.

The inorganic compound layer includes inorganic particles and a binder. The inorganic particles are selected from a combination of one or more of an aluminum oxide, a silicon oxide, a magnesium oxide, a titanium oxide, a hafnium dioxide, a tin oxide, a ceria, a nickel oxide, a zinc oxide, a calcium oxide, a zirconium oxide, an yttrium oxide, a silicon carbide, a boehmite, an aluminum hydroxide, a magnesium hydroxide, a calcium hydroxide, and a barium sulfate. The binder is selected from a combination of one or more of a polyvinylidene fluoride, a vinylidene fluoride-hexafluoropropylene copolymer, a polyamide, a polyacrylonitrile, a polyacrylate, a polyacrylic acid, a polyacrylate, a polyvinylpyrrolidone, a polyvinyl ether, a poly methyl methacrylate, a polytetrafluoroethylene, and a polyhexafluoropropylene.

The polymer layer includes a polymer, and the material of the polymer is selected from at least one of a polyamide, a polyacrylonitrile, an acrylate polymer, a polyacrylic acid, a polyacrylate, a polyvinylpyrrolidone, a polyvinyl ether, a polyvinylidene fluoride, or a poly(vinylidene fluoride-hexafluoropropylene).

VII. Electrochemical Device

An embodiment of this application provides an electrochemical device. The electrochemical device includes any device in which an electrochemical reaction occurs.

In some embodiments, the electrochemical device according to this application includes: a positive electrode that contains a positive active material capable of occluding and releasing metal ions; a negative electrode according to the embodiment of this application; an electrolytic solution; and a separator disposed between the positive electrode and the negative electrode.

In some embodiments, the electrochemical device according to this application includes, but is not limited to: any type of primary battery, secondary battery, fuel battery, solar battery, or capacitor.

In some embodiments, the electrochemical device is a lithium secondary battery.

In some embodiments, the lithium secondary battery includes, but is not limited to, a lithium metal secondary battery, a lithium-ion secondary battery, a lithium polymer secondary battery, or a lithium-ion polymer secondary battery.

VIII. Electronic Device

The electronic device according to this application may be any device that uses the electrochemical device according to the embodiment of this application.

In some embodiments, the electronic device includes, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, or the like.

The following describes preparation of a lithium-ion battery as an example with reference to specific embodiments. A person skilled in the art understands that the preparation method described in this application are merely examples. Any other appropriate preparation methods fall within the scope of this application.

### Embodiments

The following describes performance evaluation of the lithium-ion batteries according to the embodiments and comparative embodiments of this application.

I. Test Methods

Powder Properties Test Methods

1. Measuring a specific surface area: measuring an amount of a gas adsorbed on a surface of a solid under different relative pressures and a constant low temperature, and then determining a monolayer adsorption amount of a sample based on the Brunauer-Emmett-Teller (BET) adsorption theory and formula (BET formula), so as to calculate a specific surface area of the solid;

weighing out approximately 1.5˜3.5 grams of powder sample, loading the sample into a test sample tube of TriStar II 3020, degassing at approximately 200° C. for 120 minutes, and then testing the sample.

2. Measuring a carbon content: Heating the sample in a high-frequency furnace under an oxygen-rich condition to burn the sample so that carbon and sulfur are oxidized into a gas of carbon dioxide and sulfur dioxide respectively; treating the gas, and leading the gas into a corresponding absorption pool to absorb corresponding infrared radiation, and then converting the gas into a corresponding signal by using a detector; converting the signal into a value proportional to a concentration of the carbon dioxide and the sulfur dioxide after the signal is sampled by a computer and linearly rectified; adding up values obtained in the entire analysis process to obtain a sum value; after the analysis is completed, dividing the sum value by a weight value in the computer, and then multiplying by a rectification coefficient, and deducting blank values to obtain a weight percent of carbon and sulfur in the sample; testing the sample by using a high-frequency infrared carbon-sulfur analyzer (Shanghai DEKRA HCS-140).

3. Measuring an electronic conductivity of powder: applying a four-wire two-terminal method to measure voltages at both ends of a to-be-measured resistor and a current flowing through the resistor, so as to determine a resistance; and calculating a conductivity with reference to a height and a bottom area of the to-be-measured resistor; taking a specific amount of powder, adding the power into a test mold, and tapping the mold gently until the powder is level; then putting a gasket on the mold onto the sample; placing the mold onto a worktable of an electronic pressure testing machine after the sample is loaded; increasing the pressure to 500 kg (159 Mpa) at a speed of 5 mm/min; keeping a constant pressure for 60 seconds, and then release the pressure to 0; recording the pressure of the sample when the sample reaches a constant pressure of 5000±2 kg (at approximately 15˜25 seconds after the pressure rises to 5,000 kg), and reading a deformation height of the sample; recording readings of the resistance testing machine at this time, so that the electronic conductivity can be calculated according to the formula.

4. Method for measuring the content of the alkali metal element

Powder: weighing out 0.2 gram of the negative active material (Embodiments 1˜7 and Comparative Embodiments 1˜7), and putting the material into a polytetrafluoroethylene (PTFE) beaker; and recording the weight of the sample as accurate as 0.0001 g after the measured value of a digital balance becomes stable; adding 10 mL of concentrated HNO₃ and 2 mL of HF slowly to the sample, putting the sample on a 220° C. flat heater to heat and digest the sample until almost dry; adding 10 mL of nitric acid slowly to the sample, and still heating and digesting the sample for approximately 15 minutes to fully dissolve the sample; putting the dissolved sample into a fume hood and cooling the sample until a normal temperature making the sample solution homogeneous by shaking, and pouring the sample solution slowly into a funnel with a single layer of filter paper; and rinsing the beaker and filter residues for 3 times; diluting until a constant volume of 50 mL at 20±5° C. and making the sample solution homogeneous by shaking; and using an inductively coupled plasma-optical emission spectrometer (PE 7000) to measure an ion spectrum intensity of a filtrate, and calculating an ion concentration of the filtrate according to a standard curve, so as to calculate the element content in the sample.

Negative electrode: scraping off the active material on the surface of the negative electrode obtained in Embodiments 1˜7 and Comparative Embodiments 1˜7, and then performing heat treatment on the active material at 600° C. for 2 hours, and using a powder test method to measure the element content of the heat-treated sample.

5. Scanning electron microscope (SEM) test: using a PhilipsXL-30 field emission scanning electron microscope to record characterization of the SEM, and performing a test under conditions of 10 kV and 10 mA.

Testing Performance of a Coin Battery

adding LiPF₆ into a solvent in a dry argon atmosphere, where the solvent is a mixture of propylene carbonate (PC), ethylene carbonate (EC), and diethyl carbonate (DEC) (at a weight ratio of approximately 1:1:1); mixing the solution homogeneously, where a concentration of LiPF₆ is approximately 1.15 mol/L; and then adding approximately 7.5 wt % fluoroethylene carbonate (FEC), and mixing the solution homogeneously to obtain an electrolytic solution;

adding the silicon-based negative active material obtained in the embodiments and the comparative embodiments, conductive acetylene black, and a binder PAA (modified polyacrylic acid, PAA) into deionized water at a weight ratio of approximately 80:10:10; stirring the mixture to form a slurry; applying the slurry with a squeegee to form a coating that is approximately 100 μm thick; drying the material in a vacuum drying oven at approximately 85° C. for approximately 12 hours; using a stamping machine in a dry environment to cut the material into discs whose diameter is approximately 1 cm; using a metal lithium sheet as a counter electrode in a glovebox; selecting a ceglard composite film as a separator; and adding electrolytic solution to assemble a coin battery; performing LAND series of battery tests to test the charge and discharge of the battery: leaving the battery to stand for 3 hours, and then discharging the battery at 0.05 C until the voltage reaches 0.005 V; discharging the battery at 50 μA until the voltage reaches 0.005 V; leaving the battery to stand for 5 min, and then charging the battery at a 0.1 C constant current until the voltage reaches 2 V; leaving the battery to stand for 5 min, and then repeating the foregoing steps twice; and testing the battery to obtain a charge-discharge capacity curve, where first-time efficiency is calculated by dividing a lithiation capacity by a delithiation capacity, where the lithiation capacity is a capacity measured when the voltage reaches 0.8 V, and the delithiation capacity is a capacity measured when the voltage reaches 0.005 V.

Testing Performance of a Full Battery

1. Testing high-temperature cycle performance: charging the battery at a 0.7 C constant current under a 45° C. until the voltage reaches 4.4 V; charging the battery at a constant voltage until the current reaches 0.025 C; leaving the battery to stand for 5 minutes, and then discharging the battery at a 0.5 C current until the voltage reaches 3.0 V. performing a 0.7 C charging/0.5 C discharging cycle test by using the capacity obtained in this step as an initial capacity; and obtaining a capacity fading curve (the capacity fading curve uses the quantity of cycles as the X axis and uses the capacity retention rate as the Y axis) by using a ratio of the capacity obtained in each step to the initial capacity; recording the quantity of cycles when the capacity retention rate reaches 80% in the cycle test at 45° C. to compare the high-temperature cycle performance of the battery.

2. Testing a discharge rate: discharging the battery at a 0.2 C current and a 25° C. temperature until the voltage reaches 3.0 V; leaving the battery to stand for 5 minutes; charging the battery at 0.5 C until the voltage reaches 4.4 V; charging the battery at a constant voltage until the current reaches 0.05 C; leaving the battery to stand for 5 minutes; adjusting the discharge rate and performing discharge tests at 0.2 C, 0.5 C, 1 C, 1.5 C, and 2.0 C separately to obtain discharge capacities; calculating a ratio of the capacity obtained at each C-rate to the capacity obtained at 0.2 C, and comparing the rate performance by comparing the ratio.

3. Testing a direct-current resistance (DCR): using a Maccor machine to test the actual capacity of the battery at 25° C. (charging the battery at a 0.7 C constant current until the voltage reaches 4.4 V, charging the battery at a constant voltage until the current reaches 0.025 C, and leaving the battery to stand for 10 minutes; discharging the battery at 0.1 C until the voltage reaches 3.0 V, and leaving the battery to stand for 5 minutes); discharging the battery to specified states of charge (SOC) at 0.1 C, performing sampling every 5 ms in a discharge duration of 1 s, and calculating DCR values under different SOCs.

II. Preparing a Lithium-Ion Battery

Preparing a Positive Electrode

Fully stirring and homogeneously mixing LiCoO₂, conductive carbon black, and polyvinylidene fluoride (PVDF) at a weight ratio of 96.7%:1.7%:1.6% in an N-methyl-pyrrolidone solvent system to prepare a positive electrode slurry; coating the prepared positive electrode slurry onto a positive current collector aluminum foil, and performing drying and cold calendering to obtain a positive electrode.

Preparing a Negative Electrode

Mixing graphite and the silicon-based negative active material disclosed in the foregoing embodiments at a weight ratio of 89:11 to obtain a mixed negative active material whose gram capacity is 500 mAh/g; adding the mixed negative active material, the acetylene black as a conductive agent, and the PAA at a weight ratio of 95:1.2:3.8 into deionized water, fully stirring and homogeneously mixing the solution, and coating the mixture onto a Cu foil; and performing drying and cold calendering to obtain a negative electrode plate.

Preparing an Electrolytic Solution

Adding LiPF₆ into a solvent in a dry argon atmosphere, where the solvent is a mixture of propylene carbonate (PC), ethylene carbonate (EC), and diethyl carbonate (DEC) (at a weight ratio of 1:1:1); mixing the solution homogeneously, where a concentration of LiPF₆ is 1 mol/L; and then adding 10 wt % fluoroethylene carbonate (FEC), and mixing the solution homogeneously to obtain an electrolytic solution.

Preparing a Separator

Using a polyethylene (PE) porous polymer film as a separator.

Preparing a Lithium-Ion Battery

Stacking the positive electrode, the separator, and the negative electrode sequentially, and placing the separator between the positive electrode and the negative electrode to serve a function of separation; winding the stacked materials to obtain a bare cell; putting the bare cell into an outer package, and injecting the electrolytic solution, and packaging the bare cell; and performing formation, degassing, edge trimming, and other technical processes to obtain a lithium-ion battery.

III. Preparing a Silicon-Based Negative Active Material

1. Using the following method to prepare the silicon-based negative active materials disclosed in Embodiments 1˜7 and Comparative Embodiments 1˜7:

(1) dispersing carbon nanotubes and a polymer in water at a high speed for 12 hours to obtain a homogeneously mixed slurry;

(2) adding SiO (whose Dv50 is 3 μm) into the slurry homogeneously mixed in step (1), and stirring for approximately 4 hours to obtain a homogeneously mixed dispersed solution;

(3) spray-drying (at an inlet temperature of approximately 200° C., and an outlet temperature of approximately 110° C.) the dispersed solution to obtain powder; and

(4) cooling the powder, and taking out the powder sample; pulverizing the powder sample, and sifting the powder sample through a 400-mesh sieve to obtain silicon-based particles as a silicon-based negative active material.

Table 1 shows the types and content of substances used in the method for preparing the silicon-based negative active material according to Embodiments 1˜7 and Comparative Embodiments 1˜7.

TABLE 1

| | Silicon- | | | | |
|---|---|---|---|---|---|
| Serial | containing | Content of | | Type of | Content of |
| number | substrate | CNT | | polymer | polymer |
| Embodiment 1 | SiO/100 g | 0.5 | g | CMC-Na | 2 g |
| Embodiment 2 | SiO/100 g | 0.5 | g | CMC-Na | 2 g |
| Embodiment 3 | SiO/100 g | 1 | g | CMC-Na | 3 g |
| Embodiment 4 | SiO/100 g | 1 | g | CMC-Na | 3 g |
| Embodiment 5 | SiO/100 g | 1 | g | CMC-Na | 3 g |
| Embodiment 6 | SiO/100 g | 5 | g | CMC-Na | 3 g |
| Embodiment 7 | SiO/100 g | 5 | g | CMC-Na | 3 g |
| Comparative | SiO/100 g | 0.5 | g | CMC-Na | 3 g |
| Embodiment 1 | | | | | |
| Comparative | SiO/100 g | 1 | g | CMC-Na | 3 g |
| Embodiment 2 | | | | | |
| Comparative | SiO/100 g | 5 | g | CMC-Na | 3 g |
| Embodiment 3 | | | | | |
| Comparative | SiO/100 g | 12 | g | CMC-Na | 3 g |
| Embodiment 4 | | | | | |
| Comparative | SiO/100 g | 0.5 | g | — | — |
| Embodiment 5 | | | | | |
| Comparative | SiO/100 g | 1 | g | — | — |
| Embodiment 6 | | | | | |
| Comparative | SiO/100 g | 5 | g | — | — |
| Embodiment 7 | | | | | |

“—” means that this substance is not added in the preparation process.

Table 2 shows the silicon-based negative active material according to Embodiments 1˜7 and Comparative Embodiments 1˜7 as well as relevant performance parameters.

The content of each substance in Table 2 is calculated based on the total weight of the silicon-based negative active material.

TABLE 2

| | | | | | | | | | | DCR |
|---|---|---|---|---|---|---|---|---|---|---|
| | | | | | | | | Quantity | | (measured |
| | Type and | | | | | First-time | | of cycles | C-rate (2 | at a room |
| | content | Thickness | | Specific | Electronic | reversible | | when the | C discharge | temperature |
| | of alkali | of the | Carbon | surface | conductivity | capacity | | capacity | capacity/0.2 | when the |
| Serial | metal | polymer | content | area | of powder | (0.005 V~ | First-time | fades to | C discharge | SOC is |
| number | (ppm) | layer (nm) | (wt %) | (m²/g) | (μS/cm) | 0.8 V) | efficiency* | 80% | capacity) | 10%, mΩ) |
| Embod- | Na: 405 | 5 | 0.89 | 2.1 | 3.9 × 10⁷ | 1482 | 63.0% | 786 | 81.5% | 63 |
| iment 1 | | | | | | | | | | |
| Embod- | Na: 1215 | 30 | 0.89 | 1.9 | 3.8 × 10⁷ | 1480 | 63.2% | 782 | 81.9% | 65 |
| iment 2 | | | | | | | | | | |
| Embod- | Na: 810 | 15 | 1.77 | 2.4 | 6.3 × 10⁷ | 1516 | 64.5% | 826 | 83.5% | 61 |
| iment 3 | | | | | | | | | | |
| Embod- | Na: 1060 | 25 | 1.76 | 2.5 | 6.1 × 10⁷ | 1521 | 63.0% | 836 | 84.2% | 60 |
| iment 4 | | | | | | | | | | |
| Embod- | Na: 3080 | 50 | 1.75 | 2.3 | 5.8 × 10⁷ | 1495 | 62.8% | 824 | 83.1% | 62 |
| iment 5 | | | | | | | | | | |
| Embod- | Na: 1620 | 40 | 6.17 | 1.9 | 8.8 × 10⁸ | 1482 | 62.2% | 752 | 82.6% | 71 |
| iment 6 | | | | | | | | | | |
| Embod- | Na: 4050 | 80 | 6.15 | 2.1 | 8.5 × 10⁸ | 1475 | 61.6% | 730 | 81.2% | 76 |
| iment 7 | | | | | | | | | | |
| Compar- | Na: 8120 | 130 | 0.88 | 2.2 | 3.5 × 10⁷ | 1430 | 61.3% | 720 | 80.5% | 84 |
| ative | | | | | | | | | | |
| Embod- | | | | | | | | | | |
| iment 1 | | | | | | | | | | |
| Compar- | Na: 9120 | 180 | 1.77 | 2.4 | 5.7 × 10⁷ | 1443 | 60.9% | 756 | 80.9% | 80 |
| ative | | | | | | | | | | |
| Embod- | | | | | | | | | | |
| iment 2 | | | | | | | | | | |
| Compar- | Na: 9406 | 200 | 6.19 | 2.6 | 8.1 × 10⁸ | 1426 | 61.1% | 733 | 80.1% | 90 |
| ative | | | | | | | | | | |
| Embod- | | | | | | | | | | |
| iment 3 | | | | | | | | | | |
| Compar- | Na: 9406 | 200 | 13.2 | 4.6 | 1.8 × 10⁹ | 1350 | 60.2% | 627 | 78.5% | 105 |
| ative | | | | | | | | | | |
| Embod- | | | | | | | | | | |
| iment 4 | | | | | | | | | | |
| Compar- | — | | 0.99 | 3.3 | 8.5 × 10⁵ | 1385 | 60.8% | 734 | 80.0% | 98 |
| ative | | | | | | | | | | |
| Embod- | | | | | | | | | | |
| iment 5 | | | | | | | | | | |
| Compar- | — | | 1.96 | 3.8 | 4.5 × 10⁷ | 1400 | 60.4% | 746 | 80.2% | 110 |
| ative | | | | | | | | | | |
| Embod- | | | | | | | | | | |
| iment 6 | | | | | | | | | | |
| Compar- | — | | 4.76 | 4.0 | 9.8 × 10⁸ | 1367 | 58.1% | 725 | 79.5% | 121 |
| ative | | | | | | | | | | |
| Embod- | | | | | | | | | | |
| iment 7 | | | | | | | | | | |

“—” means no content of this substance.
*The first-time efficiency is calculated by dividing a lithiation capacity by a delithiation capacity, where the lithiation capacity is a capacity measured when the voltage reaches 0.8 V, and the delithiation capacity is a capacity measured when the voltage reaches 0.005 V.

As can be learned from the test results in Embodiments 1˜7 and Comparative Embodiments 1˜7, in contrast with the silicon-based negative active material whose silicon-containing substrate surface includes merely CNT (but includes no polymer), the lithium-ion battery prepared by using the silicon-based negative active material whose surface includes both a polymer and a CNT composite layer achieves a lower resistance, higher first-time efficiency, higher cycle stability, and higher rate performance.

Further, as can be learned from the foregoing test results, in a case that the surface of the silicon-based negative active material includes a polymer and a CNT composite layer, when the content of the alkali metal ions is less than approximately 5,000 ppm, the resistance of the lithium-ion battery is further reduced, and the first-time efficiency, the cycle stability, and the rate performance are further enhanced.

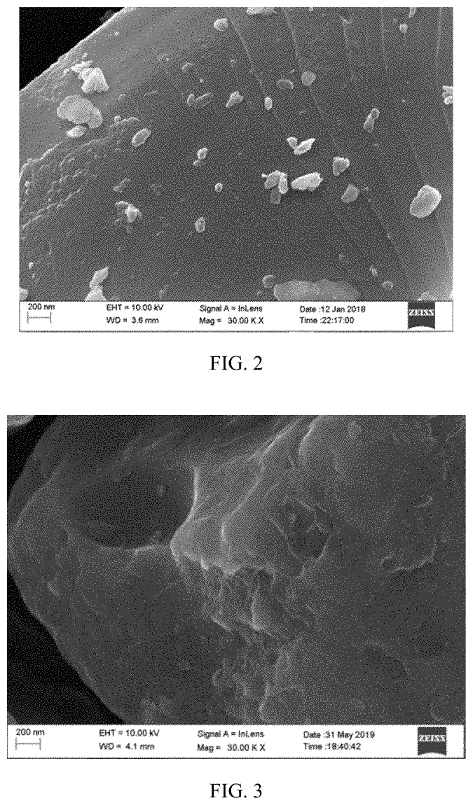

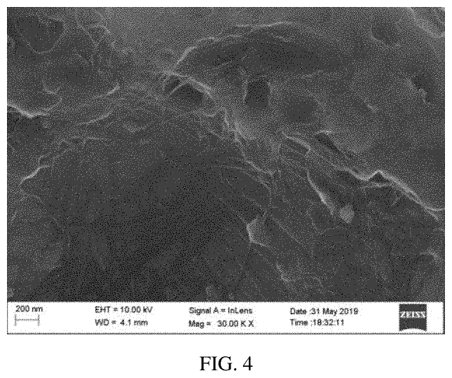

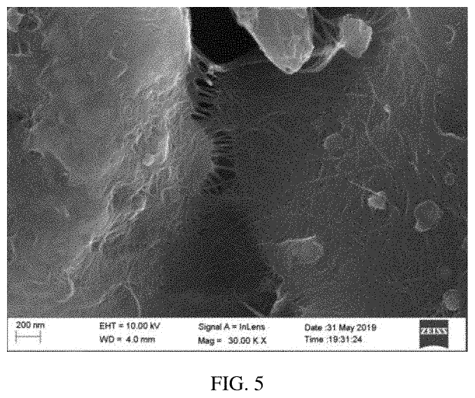

FIG. 2 shows a scanning electron microscope (SEM) image of a surface of a silicon-based negative active material according to Comparative Embodiment 5 of this application; FIG. 3 shows an SEM image of the surface of the silicon-based negative active material according to Embodiment 1 of this application; FIG. 4 shows an SEM image of the surface of the silicon-based negative active material according to Embodiment 3 of this application; and FIG. 5 shows an SEM image of the surface of the silicon-based negative active material according to Embodiment 6 of this application.

FIG. 2-5 show surface images of carbon nanotubes and polymers, where the content of the carbon nanotubes and polymers differs between the embodiments. As can be learned from the drawings, in contrast with FIG. 2 in which no polymer is added, the carbon nanotubes and the polymer in FIG. 3 to FIG. 5 are distributed on the surface of the silicon-based negative active material more homogeneously and are connected to adjacent silicon-based particles. This indicates that a composite of the carbon nanotubes and the polymer can be distributed on the surface of the silicon-based material more homogeneously.

References to “embodiments”, “some embodiments”, “an embodiment”, “another example”, “example”, “specific example” or “some examples” throughout the specification mean that at least one embodiment or example in this application includes specific features, structures, materials, or characteristics described in the embodiment(s) or example(s). Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment or example in this application. In addition, specific features, structures, materials, or characteristics herein may be combined in one or more embodiments or examples in any appropriate manner.

Although illustrative embodiments have been demonstrated and described above, a person skilled in the art understands that the above embodiments shall not be construed as a limitation on this application, and changes, replacements, and modifications may be made to the embodiments without departing from the spirit, principles, and scope of this application.

What is claimed is:

1. A negative electrode material, comprising: silicon-based particles; wherein the silicon-based particles comprise a silicon-containing substrate, a polymer layer is provided on at least a part of a surface of the silicon-containing substrate, the polymer layer comprises carbon nanotubes and alkali metal ions; the alkali metal ions comprise Li+, Na+, K+, or any combination thereof; and based on a total weight of the silicon-based particles, a content of the alkali metal ions is approximately 50˜5,000 ppm.

2. The negative electrode material according to claim 1, wherein the polymer layer comprises lithium carboxymethyl cellulose (CMC-Li), sodium carboxymethyl cellulose (CMC-Na), potassium carboxymethyl cellulose (CMC-K), lithium polyacrylic acid (PAA-Li), sodium polyacrylic acid (PAA-Na), potassium polyacrylic acid (PAA-K), lithium alginate (ALG-Li), sodium alginate (ALG-Na), potassium alginate (ALG-K), or any combination thereof.

3. The negative electrode material according to claim 1, wherein the silicon-containing substrate comprises SiOₓ, wherein 0.6≤x≤1.5.

4. The negative electrode material according to claim 1, wherein the silicon-containing substrate comprises Si, SiO, SiO₂, SiC, or any combination thereof.

5. The negative electrode material according to claim 4, wherein a grain particle size of Si is less than approximately 100 nm.

6. The negative electrode material according to claim 1, wherein, based on the total weight of the silicon-based particles, a content of the polymer layer is approximately 0.05-15 wt %.

7. The negative electrode material according to claim 1, wherein, based on the total weight of the silicon-based particles, a content of the carbon nanotubes is approximately 0.01-10 wt %.

8. The negative electrode material according to claim 1, wherein, based on the total weight of the silicon-based particles, a weight ratio of a polymer to the carbon nanotubes in the polymer layer is approximately 1:10-10:1.

9. The negative electrode material according to claim 1, wherein a thickness of the polymer layer is approximately 5-200 nm.

10. The negative electrode material according to claim 1, wherein an average particle size of the silicon-based particles is approximately 500 nm-30 μm.

11. The negative electrode material according to claim 1, wherein a specific surface area of the silicon-based particles is approximately 1-50 m²/g.

12. A negative electrode, comprising: a negative electrode material, the negative electrode material comprises silicon-based particles, wherein the silicon-based particles comprise a silicon-containing substrate, a polymer layer is provided on at least a part of a surface of the silicon-containing substrate, the polymer layer comprises carbon nanotubes and alkali metal ions; the alkali metal ions comprise Li+, Na+, K+, or any combination thereof; and based on a total weight of the silicon-based particles, a content of the alkali metal ions is approximately 50˜5,000 ppm.

13. The negative electrode according to claim 12, wherein based on the total weight of the silicon-based particles, a content of the polymer layer is approximately 0.05-15 wt %.

14. The negative electrode according to claim 12, wherein a thickness of the polymer layer is approximately 5-200 nm.

15. The negative electrode according to claim 12, wherein a specific surface area of the silicon-based particles is approximately 1-50 m²/g.

16. An electrochemical device, comprising the negative electrode according to claim 12.

17. An electronic device, comprising the electrochemical device according to claim 16.
